(19) United States
(12) Patent Application Publication
(10) Pub. No.: US 2004/0046720 A1
(43) Pub. Date: Mar. 11, 2004

(54) Image display apparatus and control method thereof

(76) Inventors: Yoshifumi Nagai, Anan-shi (JP); Hiroshi Tsujimoto, Anan-shi (JP); Yoshiyuki Nakano, Anan-shi (JP); Ryuhei Tsuji, Anan-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/646,738

(22) Filed: Aug. 25, 2003

Related U.S. Application Data
(62) Division of application No. 10/182,828, filed on Aug. 2, 2002.
Application No. 10/182,828 is a 371 of international application No. PCT/JP01/00807, filed on Feb. 5, 2001.

(30) Foreign Application Priority Data
Feb. 3, 2000 (JP) 032645/2000
Sep. 4, 2000 (JP) 266989/2000

(51) Int. Cl. G09G 3/32; G09G 5/10

(52) U.S. Cl. 345/82; 345/690

(57) ABSTRACT

An image display exhibiting high reproducibility by correcting variation in the chromaticity of light emitting elements and thereby uniforming the color tone of pixels, and a control method thereof. The image display comprises a display section where light emitting elements of a plurality of color tones are arranged for each pixel, a drive section for supplying the light emitting elements of each pixel with a drive current according to image data concerning the color tones, and a chromaticity correcting section for distributing a specified part of drive current, supplied from the drive section to a light emitting element corresponding to at least one of the color tones of each pixel, to a light emitting element corresponding to one or more other color tone of the pixel.

### TECHNICAL FIELD

The present invention relates to an image display apparatus comprising light emitting elements corresponding to a plurality of color tones disposed in each pixel and a control method thereof, more specifically to an image display apparatus furnished with a function of correcting amount of light emission corresponding to dispersion of light emitting element characteristics and to a control method thereof.

### BACKGROUND ART

Recently, high-luminance light emitting elements, such as light emitting diodes (hereinafter, occasionally abbreviated to LEDs), have been developed for each of RGB that stands for red, green, blue known as primary colors of light, and the production of large-scale self-luminance full color displays being started. Among others, LED displays have characteristics that they can be lightweight and slimmed-down, and that they consume less power, etc. Hence a demand for the, LED displays as large-scale displays that can be used outdoors has been sharply increasing.

In the case of a large-scale LED display such as being installed in outdoors, the LED display is generally assembled by a plurality of LED units. Each LED display unit displays each part of the whole display data. LED units have light emitting diodes, which are one set of RGB, aligned on substrates in a pixel matrix shape. Each LED unit operates similarly to the LED display mentioned above. In large-scale LED display units, plenty of LEDs are employed, for example, 300 in longitude×640 in width, about 300,000 pixels of LEDs are employed. Further, each pixel is composed of three dots or more LEDs, each dot emitting in R, G, B, respectively.

Generally, the dynamic driving method is used as a driving method of the LED display. To be more specific, in the case of an LED display composed of a dot matrix with m rows and n columns, the anode terminals of the LEDs positioned on each row are commonly connected to one common source line, and the cathode terminals of the LEDs positioned on each column are commonly connected to one current supply line. As many source line lines as m rows are switched ON successively at a predetermined cycle, and a driving current is supplied to as many current supply lines as n columns according to image data corresponding to ON time. Consequently driving current according to image data is applied to the LED in each pixel, whereby an image is displayed.

To represent image data exactly on the LED display, each LED is required to have a uniform luminous intensity characteristic (driving current—luminance characteristics etc.). However, LEDs are not always produced uniformly in practice. LEDs are produced onto wafers by a semiconductor manufacturing technology. LEDs have a dispersion of luminous emitting characteristic or emission spectrum according to production lots, wafers or chips. Therefore, it is required to correct the driving current corresponding to each image data based on a dispersion of LED characteristic such as luminance or chromaticity for each pixel.

A luminance correcting method has been developed as a image data correcting means such as a method described in Japanese examined patent publication No. 2,950,178 etc. For example, one method corrects any LEDs by increasing or decreasing amount of the driving current based on luminous intensity characteristic dispersion of each LED, so as to emit same luminous intensity corresponding to same value of image data

Also, another method corrects by using luminance-corrected image data for each LED to display high quality image. Specifically, luminance-correcting data corresponding to each LED is stored in a correcting data storing portion in a control circuit to control lighting of the LED display. A ROM is used as the correcting data storing portion, for example. The control circuit corrects to display image with correcting based on the correcting data stored in the ROM.

However, though any of the methods mentioned above can correct luminance, none of them can not correct chromaticity. Each LED has not only dispersion of luminance, but also of chromaticity. Therefore, even if only luminance correcting is performed to uniform luminance among pixels, it can not correct chromaticity of each pixel. Accordingly displayed image are grainy because of a dispersion of chromaticity, there is a problem that quality of displayed image is reduced. In particular the more number of color tones, the more dispersion of chromaticity is notable. To display high-quality image in full-color display using RGB, not only luminance correcting but also chromaticity are important.

The present invention is devised to solve the above problems. The object of the invention is to provide an image display apparatus and its control method capable of displaying uniformed and well-reproducibility high-quality image by correcting chromaticity of light emitting elements for each color, even if an image display apparatus employs light emitting elements with a dispersion of their characteristics.

### DISCLOSURE OF THE INVENTION

To achieve the object, the image display apparatus of the invention comprises light emitting elements corresponding to a plurality of color tones disposed in each pixel, wherein, a main current for luminance control is supplied to a spontaneous light emitting element corresponding to one of the plurality of color tones in a pixel, and a correcting current for chromaticity correcting is added to other light emitting element corresponding to at least one of the other color tones in the pixel, wherein, the main current and the correcting current are controlled by a pulse driving period.

Thus, it is possible to provide an image display apparatus, which can make chromaticity of each pixel uniform despite a dispersion of chromaticity of light emitting elements. It is also possible to provide an image display apparatus, which can adjust luminance and chromaticity without modulation of chromaticity and can accurately correct them with stability.

In addition, during, before or after light emission one of a plurality of color tones of light emitting elements, the other color tones of light emitting elements emit so as to correct chromaticity of the one of a plurality of color tones of light emitting elements. Accordingly, it is possible to prevent flicker of high quality display with reducing a deviation of chromaticity.

In the image display apparatus of the invention, each pixel is composed of three color tones of light emitting elements, and two color tones of light emitting elements other than the light emitting element corresponding to the color tone to be performed chromaticity correcting emit a small amount of light to correct a dispersion of chromaticity of light emitting elements corresponding to each color tone.

In the image display apparatus of the invention, the three color tones of light emitting elements, of which each pixel is composed, are red, blue and green.

In the image display apparatus of the invention, the main current and the correcting current are controlled by time-sharing.

In the image display apparatus of the invention, amount of light emission by the main current and the correcting current is adjusted by controlling the number of pulse driving or the ratio of frequency of reference clocks (widths of reference clock pulses).

The image display apparatus of the invention comprises light emitting elements corresponding to RGB of color tones disposed in each pixel, wherein, in light emission of each light emitting element Li (i=R, G, B) based on image data Di (i=R, G, B) in respective pixels, amount of light emission Ak+A′k is controlled by the number of pulse driving or the ratio of frequency of reference clocks (widths of reference clock pulses), so as to add amount of light emission Ak (k≠i) of at least one of the other light emitting elements Lk (k≠i) in the respective pixels based on amount of light emission Ai (i=R, G, B) of the light emitting element Li to amount of light emission Ak (k≠i) of the light emitting elements Lk (k≠i) based on image data Dk (k≠i).

In the image display apparatus of the invention, the amount of light emission A′k (k≠i) of the light emitting elements Lk based on amount of light emission Ai (i=R, G, B) of the light emitting element Li is set so that chromaticity of each pixel based on maximum value of the image data Di (i=R, G, B) is corrected to reference chromaticity.

The control method of an image display apparatus, of the invention, with light emitting elements corresponding to a plurality of color tones disposed in each pixel, in which a main current for luminance control is supplied to a spontaneous light emitting element corresponding to one of the plurality of color tones in a pixel and a correcting current for chromaticity correcting is added to other light emitting element corresponding to at least one of the other color tones in the pixel, comprising a step in that the main current and the correcting current are controlled by pulse driving period.

The control method of an image display apparatus, of the invention, with light emitting elements corresponding to RGB of color tones disposed in each pixel comprising a step in that, in light emission of each light emitting element Li (i=R, G, B) based on image data Di (i=R, G, B) in respective pixels, amount of light emission Ak+A′k is controlled by the number of pulse driving or the ratio of frequency of reference clocks (widths of reference clock pulses), so as to add amount of light emission A′k (k≠i) of at least one of the other light emitting elements Lk (k≠i) in the respective pixels based on amount of light emission Ai (i=R, G, B) of the light emitting element Li to amount of light emission Ak (k≠i) of the light emitting elements Lk based on image data Dk (k≠i).

In the image display apparatus of the invention, the light emitting elements are light emitting diodes.

In the control method of the image display apparatus of the invention, the light emitting elements are light emitting diodes. In the image display apparatus of the invention, a driving period corresponding to one image frame is divided into three divided periods, wherein, a pulse driving current for color tone corresponding to the light emitting element as the main currents is supplied in one of the three divided periods as a main displaying period, and pulse driving currents for color tones corresponding to the other color tones to control the amount of light emission for correcting chromaticity to be added as the correcting currents are supplied in the other two of the three parts as color correcting periods, wherein, amount of light emission by the main current and the correcting currents is adjusted by controlling widths of reference clock pulses.

### BRIEF DESCRIPTION OF DRAWINGS

FIG. 1 is a schematic view showing an example of a pixel, which is composed of light emitting elements L_{R}, L_{G}, L_{B} corresponding to a plurality of color tones R, G, B, in an image display portion of the invention.

FIG. 2 is a schematic view showing an example of selected reference chromaticity of the invention by using a chromaticity diagram.

FIG. 3 is a block diagram showing constitution of an image display apparatus of the invention.

FIG. 4 is a view showing a composite example of a pulse driving current in a chromaticity-correcting portion of an embodiment 1 of the invention.

FIG. 5 is a block diagram showing constitution of a distributing portion of an image display apparatus of the invention.

FIG. 6 is a schematic view showing a flow of distributing of a driving current according to an R distributing block and an R compositing portion in a distributing portion of the invention.

FIG. 7 is a view showing a pulse driving current in one image frame period in a chromaticity-correcting portion of an embodiment 2 of the invention.

FIG. 8 is a view showing a pulse driving current in one image frame period in a chromaticity-correcting portion of an embodiment 3 of the invention.

FIG. 9 is a schematic view showing a chromaticity correcting system used in a chromaticity correcting method for an image display apparatus of a embodiment 4.

FIG. 10 is a block diagram showing constitution of a display unit of an image display apparatus of an embodiment 5 according to the invention.

FIG. 11 is a block diagram showing constitution of an image display apparatus of an embodiment 5 of the invention.

FIG. 12 is a block diagram showing an example of an image display apparatus of an embodiment 6 of the invention.

FIG. 13 is a block diagram showing constitution of an image display apparatus of an embodiment 7 of the invention.

FIG. 14 is a time chart showing an operation of chromaticity correcting in the image display apparatus of FIG. 13.

### BEST MODE FOR CARRYING OUT THE INVENTION

The following description will describe an embodiment of the invention with reference to the drawings. It should be appreciated, however, that the embodiment described below is an illustration of a image display apparatus and a control method thereof to give a concrete form to technical ideas of the invention, and a image display apparatus and a control method thereof of the invention are not especially limited to description below.

Furthermore, in this specification numbers corresponding to members shown in the embodiment described below are added to members shown in “Claims” and “Disclosure of The Invention” for ease of understanding claims. It should be appreciated that the members shown in claims are not especially limited to members in the embodiments.

An image display control method of the invention will be described below. This method relates to an image display control method for displaying in multicolor with controlling amount of light emission A_{R}, A_{G}, A_{B} of light emitting elements L_{R}, L_{G}, L_{B} corresponding to a plurality of color tones R, G, B, which are disposed in a display portion 10 in each pixel, based on image data D_{R}, D_{G}, D_{B} according to R, G, B in each pixel.

LEDs etc are used as light emitting elements. In an example shown below, one pixel is composed of a set of adjacent three light emitting diodes capable of emitting red, green, and blue (R, G, B) light respectively. The sets of adjacent LEDs in pixels can display in full-color. However, this invention should not be limited to this composition, the light emitting elements forming one pixel may be arranged in such a manner that LEDs corresponding to two colors are provided in close proximity, or two or more LEDs are provided per color.

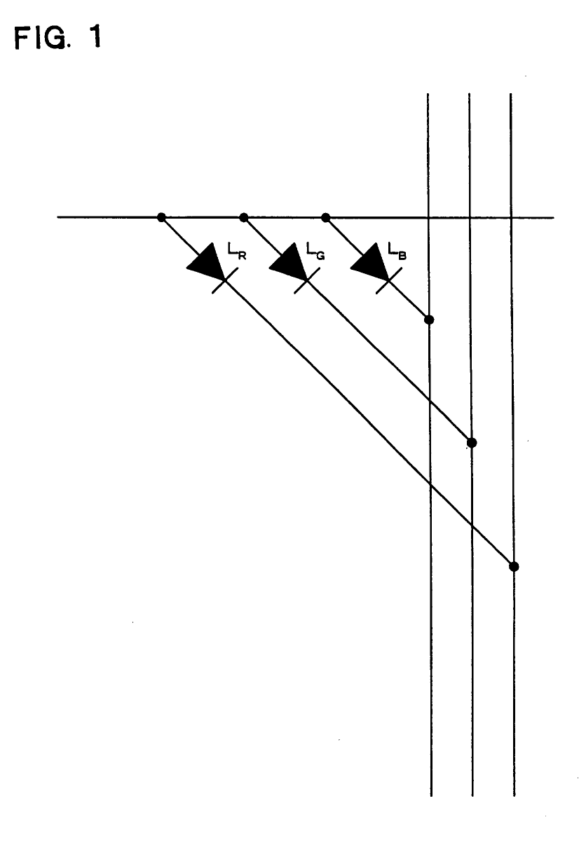

FIG. 1 is a schematic view showing an example of a pixel, which is composed of light emitting elements L_{R}, L_{G}, L_{B} corresponding to a plurality of color tones R, G, B, in a image display portion 10. Although one pixel is composed of a set of adjacent three light emitting diodes corresponding to dots in this example, it is capable of displaying in full color that each of R, G, B is composed of al least one dots. In this example, an anode terminal of each light emitting element is connected with one common source line commonly, cathode lines of the light emitting elements L_{R}, L_{G}, L_{B} corresponding to R, G, B are connected with current lines respectively. For example, amount of light emission of the light emitting elements L_{R}, L_{G}, L_{B} is controlled by a driving current supplied to the current line. Thus, the light emitting elements L_{R}, L_{G}, L_{B} are disposed in each pixel in a display portion 10, it achieves a image display control for displaying in multicolor with controlling amount of light emission A_{R}, A_{G}, A_{B} by amount and/or driving period of the driving current, which is supplied based on each of image data D_{R}, D_{G}, D_{B}.

In this case, amount of light emission A′k (k≠i) corresponding to a correcting part described later can be emitted in same period as light emitting time of the light emitting elements Li (i=R, G, B). However, in the case that a deference of the period is within an after-image for the human, the light emission may not be emitted in the same period.

To prevent a dispersion of chromaticity in each pixel caused by a dispersion of manufacturing each light emitting element, in the invention, in light emission of at least one of the light emitting elements Li (i=R, G, B) based on the image data Di (i=R, G, B) in respective pixels, amount of light emission A′k (k≠i) of at least one of the other light emitting elements Lk (k≠i) in the respective pixels based on amount of light emission Ai (i=R, G, B) of the light emitting element Li is added to amount of light emission Ak (k≠i) of at least one of the other light emitting elements Lk based on the image data Dk (k≠i), so as to control amount of light emission of the light emitting element Lk to Ak+A′k.

An example of the control method adding amount of light emission A′k (k≠i) to the amount of light emission of A′k light emitting elements Lk (k≠i) corresponding to one color tone based on the image data Dk will be described below.

In this example, amount of light emission A′k of at least one of the other light emitting elements Lk (k≠i) based on amount of light emission Ai of the light emitting element Li is set as multiplying amount of light emission Ai of the color tone and a distributing ratio of each of the other color tones. In this example, the distributing ratios are represented such that the distributing ratios G, B corresponding to R are r_{G}, r_{B}; the distributing ratios B, R corresponding to G are g_{B}, g_{R}; the distributing ratios R,G corresponding to B are b_{R}, b_{G}, respectively. Shortly, when amount of light emission of the light emitting elements L_{R}, L_{G}, L_{B} based on the image data D_{R}, D_{G}, D_{B} are A_{R}, A_{G}, A_{B} respectively, total amount of light emission A″_{R}, A″_{G}, A″_{B} of the light emitting elements L_{R}, L_{G}, L_{B} are controlled by adding A′_{R}, A′_{G}, A″_{B} to A_{R}, A_{G}, A_{B}. The amount of light emission A″_{R}, A″_{G}, A″_{B} are represented with the following formula

$$[ \begin{matrix}{A}_{R}^{″} \\ {A}_{G}^{″} \\ {A}_{B}^{″}\end{matrix} ] = [ \begin{matrix}{A}_{R} + {A}_{R}^{′} \\ {A}_{G} + {A}_{G}^{′} \\ {A}_{B} + {A}_{B}^{′}\end{matrix} ] = [ \begin{matrix}1 & {g}_{R} & {b}_{R} \\ {r}_{G} & 1 & {b}_{G} \\ {r}_{B} & {g}_{B} & 1\end{matrix} ] [ \begin{matrix}{A}_{R} \\ {A}_{G} \\ {A}_{B}\end{matrix} ] \qquad [ Formula 1 ]$$

Accordingly, though amount of light emission Ai (i=R, G, B) of each light emitting element Li (i=R, G, B) has one output characteristics against the image data Di (i=R, G, B) in a control method for image displaying in the related art, amount of light emission A″i (i=R, G, B) of each light emitting element Li (i=R, G, B) in an image display control method of the invention is not defined as one output characteristics against the image data Di (i=R, G, B), and also depends on the amount of light emission of the other light emitting elements Lk (k≠i) corresponding to the other color tones based on the image data Dk (k≠i).

Next, an example of a method setting amount of light emission A′k to be added to the light emitting element Lk corresponding to amount of light emission Ai of the light emitting element Li is described. For example, in the case that a light emitting diode (LED) is used as the light emitting element, amount of light emission of the light emitting elements Lk (k≠i) corresponding to the other colr tones is set to correct chromaticity of the pixel, which is based on the maximum value of the image data Di (i=R, G, B) into reference chromaticity respectively. So that a dispersion of chromaticity caused by a dispersion of a wavelength or output characteristics of the LED can be corrected. In this case, the reference chromaticity are preferably selected to three chromaticity points, which can be represented by any combination of LEDs corresponding to R, G, B in a range of dispersion of manufacturing respectively.

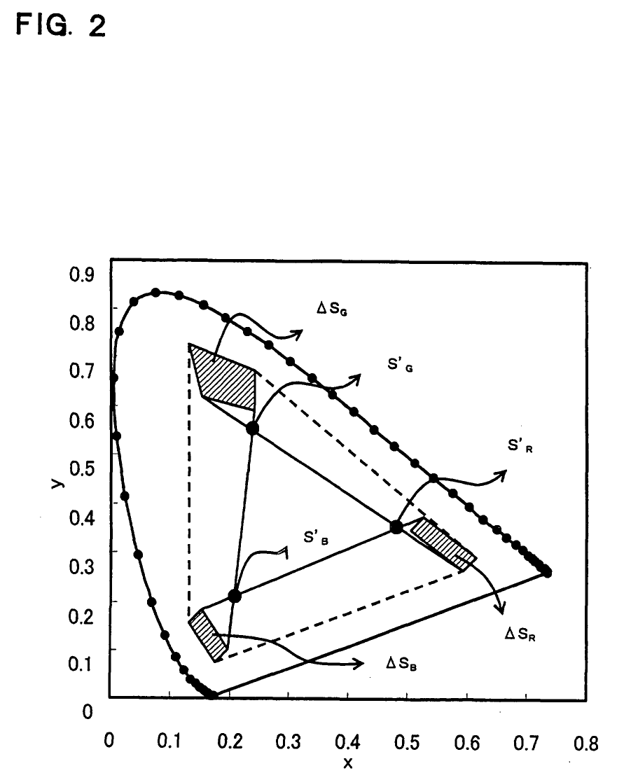

A concrete example of a method selecting reference chromaticity will be described with FIG. 2 below. A area ΔSi (i=R, G, B) showing the dispersion of chromaticity is drawn on a chromaticity diagram of FIG. 2, when the LED corresponding to each of R, G, B emits at maximum amount of light emission Ai_{Max} based on the maximum values of the image data Di_{Max} (i=R, G, B) corresponding to each color tone. In FIG. 2, each area ΔSi is schematically shown in a polygonal shape. Here, it can be considered that all LEDs are distributed in the areas ΔSi (shown as areas with diagonal lines in FIG. 2).

A trigonal shape is formed by connecting vertexes of the areas ΔSi. Then vertexes are selected in the vertexes of the each area ΔSi such that they can make a trigonal shape, which is formed by intersection points of lines connecting the vertexes of the areas ΔSi each other, the smallest size. Finally, vertexes S′_{R}, S′_{G}, S′_{B} of the smallest trigonal shape ΔS′_{R}S′_{G}S′_{B} are selected as the reference chromaticity corresponding to R, G, B respectively. Therefore, all chromaticity in a range of the area of the trigonal shape ΔS′_{R}S′_{G}S′_{B} can be represented by selecting S′_{R}, S′_{G}, S′_{B} as the reference chromaticity.

Accordingly selecting the reference chromaticity in this method, any combination of the LEDs can represent any chromaticity in the range (the area of the trigonal shape ΔS′_{R}S′_{G}S′_{B}). Correcting chromaticity can be achieved by light emission of the other color tones. Thus a dispersion of displaying chromaticity among each pixel can be reduced drastically, a dispersion of chromaticity in a same LED unit 1 can be restrained.

In FIG. 2, the range of dispersion of chromaticity is shown larger exaggeratingly for ease of explanation. Therefore, it seems as if the chromaticity range capable of representation in the display portion 10 becomes much smaller (the range is reduced from dashed lines into the tirgonal shape ΔS′_{R}S′_{G}S′_{B}). But the LED display has characteristics that is sufficiently larger than a CRT display for example, so that a display apparatus of the invention applied to the LED unit has still a larger chromaticity representation range than that of a CRT display. Furthermore, in the case that amount of light emission A′k added to the LEDs corresponding to the other color tones is set as amount of light emission, which is multiplied by a distributing ratio and amount of light emission Ai, to correct chromaticity, the correction is performed in the whole chromaticity range continuously. Therefore, a dispersion of chromaticity is restrained not only in proximity to R, G, B but also the whole chromaticity range.

In this method, though it is described that a control method for image displaying, in which, in light emission of each of the light emitting elements Li (i=R, G, B) based on the image data Di in respective pixels, amount of light emission A′k (k is not i) of any of the other light emitting elements Lk (k is not i) in the respective pixels corresponding to amount of light emission Ai (i=R, G, B) of the light emitting element Li is added to the amount of light emission Ak of any of the light emitting elements Lk based on the image data Dk (k is not i), so as to control amount of light emission to Ak+A′k, amount of light emission A′k of at least one of the other light emitting elements Lk (k≠i) in the respective pixels based on amount of light emission Ai may be added to the amount of light emission Ak of one or more of the other light emitting elements Lk in the respective pixels based on the image data Dk, so as to control amount of light emission to Ak+A′k.

For example, considering a color difference limen on the chromaticity diagram, in sensitivity of the human in R area, B direction is less sensitive than G direction. Therefore, amount of light emission A′_{G} of the LED corresponding to only G based on amount of light emission A_{R} may be added so as to control amount of light emission to A_{G}+A′_{G}. Further, in LEDs composed of gallium nitride compounds at present, a dispersion of chromaticity of LED corresponding to G is more than that of R or B. So that when a dispersion of chromaticity of LEDs corresponding to R, B is sufficiently less, amount of light emission A′_{R}, A′_{B} of LEDs corresponding to R and/or B corresponding to amount of light emission of A_{R} A_{B} may be added so as to control amount of light emission to A_{R}+A′_{R} and/or A_{B}+A′_{B} for only G of LED. However, the color difference limen is relatively small in B area, so that sensitivity of the human in B area is high against a deference of chromaticity. Therefore, even a dispersion of chromaticity of the LED corresponding to B is small, the LED corresponding to B may be corrected for its dispersion of chromaticity. Needless to say, it is not limited to above-mentioned examples which LEDs corresponding to R, G, B are omitted to correct their dispersion of chromaticity, they are selected properly according to a range of a chromaticity dispersion corresponding to R, G, B, a shape of the color difference limen in each chromaticity area.

Furthermore, in the case that a image display control for displaying in multicolor with controlling amount of light emission A_{R}, A_{G}, A_{B} of the light emitting elements L_{R}, L_{G}, L_{B} is performed by amount and/or driving period of the driving current, which is supplied based on each of image data D_{R}, D_{G}, D_{B}, amount of light emission A′k of light emitting elements Lk based on amount of light emission Ai of the light emitting element Li is controlled by increasing driving currents supplied to the light emitting elements Lk preferably. Because amount of light emission is controlled simultaneously in each light emitting element during same driving period, so that display flicker can be minimized.

Here, LEDs are used as the light emitting elements in the examples, the light emitting elements of the invention are not especially limited to LEDs. The invention can be preferably applied to an image display apparatus having light emitting elements with a dispersion of chromaticity.

Besides, a dispersion of chromaticity relates to a dispersion of luminance, therefore correcting both dispersions simultaneously is important considering correction of an image display apparatus.

A semiconductor light emitting element capable of emitting various kinds of light can be used as the light emitting diode. Examples of the semiconductor element include those using, as a light emitting layer, a semiconductor, such as GaP, GaAs, GaN, InN, AlN, GaAsP, GaAlAs, InGaN, AlGaN, AlGaInP, and InGaAlN. Also, the structure of the semiconductor may be the homo structure, the hetero structure, or the double hetero structure having the MIS junction, the PIN junction, or the PN junction.

By selecting materials of the semiconductor layer and a degree of mixed crystals thereof, it is possible to select a wavelength of light emitted from the semiconductor light emitting element that ranges from an ultraviolet ray to an infrared ray. Further, in order to offer a quantum effect, a single-quantum-well structure or multi-quantum-well structure using the light emitting layer of a thin film is also available.

Besides the light emitting diodes for RGB primary colors, it is also possible to use a light emitting diode that combines light from an LED and a fluorescent material that emits light upon excitation by light from the LED. In this case, by using a fluorescent material that excited by light from the light emitting diode and emits light transferred into long wavelength light, it is possible to obtain a light emitting diode capable of emitting light of a color tone, such white, with satisfactory linearity by using one kind of light emitting element.

Further, a light emitting diode of various shapes can be used. Examples of the form include a shell type made by electrically connecting an LED chip serving the light emitting element to a lead terminal and by coating the same with molding compounds, a chip type LED, a light emitting element per se, etc.

Embodiments of the invention will be described below.

[Embodiment 1]

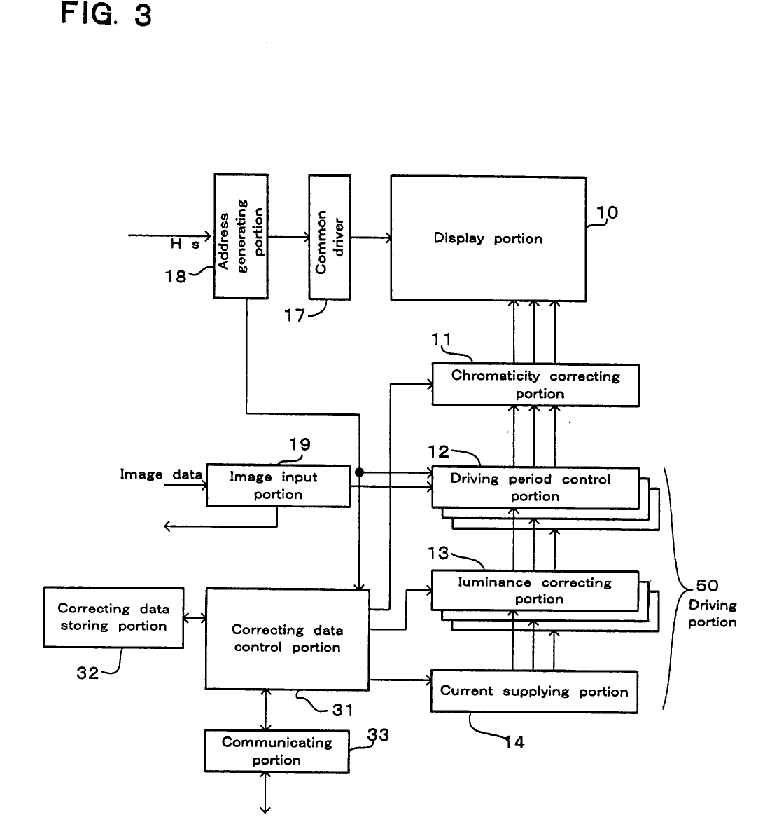

FIG. 3 is a block diagram schematically showing an embodiment of an image display apparatus according to the invention. The image display apparatus shown in this figure is an embodiment applied to an LED unit displaying with dividing one image into a plurality of image areas. The image display apparatus shown in FIG. 3 includes: a display portion 10; a correcting data storing portion 32; a correcting data control portion 31 connected with the correcting data storing portion 32; a communicating portion 33 connected with the correcting data control portion 31; a driving current supplying portion 14 connected with the correcting data control portion 31; a luminance correcting portion 13; chromaticity correcting portion 11; an image input portion 19 receiving image data input from an external; a driving period control portion 12 input the image data from the image input portion 19; an address generating portion 18; and a common driver 17.

The image display apparatus of the invention can display a motion image or a still image with displaying 30 or more frames of screen as image frames per second, for example. The image display apparatus using light emitting elements generally displays higher number of image frames per second than that using a CRT, with a high refresh rate. The display portion 10 shown in FIG. 3 displays an image corresponding to an allocated image area of the plurality of divided image areas. For example, one pixel is composed of a combination of each LED corresponding to three color tones R, G, B. The display portion 10 is composed of a plurality of pixels aligned in a matrix shape with m row and n column.

The correcting data storing portion 32 stores correcting data, which is necessary to correct luminance and chromaticity of the display portion 10. The correcting data storing portion 32 is composed of a memory device such as a RAM, a flash memory, or an EEPROM etc. The correcting data storing portion 32 stores various correcting data necessary for image correcting. The correcting data storing portion 32 can store: white balance correcting data and plane luminance correcting data, which are necessary data to control predetermined amount of a current supplied corresponding to each color tone in the current supplying portion 14; pixel luminance correcting data necessary to correct luminance in each dot in the luminance correcting portion 13; chromaticity correcting data according to a predetermined part of a driving current to be distributed to the light emitting elements corresponding to at least one of the other color tones and necessary to correct chromaticity in each pixel; and so on, for example.

The correcting data control portion 31 reads various correcting data stored in the correcting data storing portion 32, and write them into the current supplying portion 14, the luminance correcting portion 13, and the chromaticity correcting portion 11 respectively.

The image data input from an external is input to the driving period control portion 12 via the image input portion 19. The driving period control portion 12 is supplied a current, whose amount is corrected by the current supplying portion 14 and the luminance correcting portion 13, and controls a driving period of the supplied driving current by pulse width based on the image data, then input it to the chromaticity correcting portion 11 as a pulse driving current. Besides, the driving period control portion 12 can control the chromaticity correcting portion 11 by a number of constant pulses or the like instead of the pulse width.

The pulse driving current input from the driving period control portion 12 is further corrected by the chromaticity correcting portion 11. The chromaticity correcting portion 11 corrects the pulse driving current supplied to each LED based on the chromaticity correcting data, so as to correct a chromaticity deference caused by a dispersion of each LED.

The address generating portion 18 generates an address denoting a row corresponding to an input synchronizing signal Hs, then input it into the common driver 17, the correcting data control portion 31, and the driving period control portion 12. The common driver 17 drives the row corresponding to the input address. The chromaticity correcting portion 11 is also furnished with a function of a segment driver, and drives a row corresponding to the driving period control portion 12 so as to drive one pixel with the common driver 17 in time-sharing for matrix displaying.

Next, the luminance correcting and chromaticity correcting of the display portion 10 will be described. In the current supplying portion 14, the driving current supplied from the current supplying portion 14 to the luminance correcting portion 13 is corrected in each of R, G, B based on the white balance correcting data and the plate luminance correcting data stored in the correcting data storing portion 32, Thus, white balance and plate luminance of the whole LED unit 1 are corrected, so that a dispersion of each LED is restrained.

In the luminance correcting portion 13, the driving current supplied to each LED is corrected in each of R, G, B of each pixel based on the pixel luminance correcting data stored in each of R, G, B of each pixel in the correcting data storing portion 32. Thus, luminance of each pixel is adjusted, a dispersion of luminance of each pixel in the same LED unit 1 is restrained.

In the chromaticity correcting portion 11, the pulse driving current supplied from the driving period control portion 12 is corrected in each of R, G, B of each pixel based on the chromaticity correcting data stored in each of R, G, B of each pixel in the correcting data storing portion 32. Thus, chromaticity of each pixel is corrected, so that chromaticity of each of R, G, B in each LED unit is adjusted into a reference chromaticity, and also a dispersion of chromaticity of each pixel in the same LED unit 1 is exaggeratedly restrained.

Therefore, the invention can restrain not only a dispersion of luminance and chromaticity of each LED unit, but also a dispersion of luminance and chromaticity of each pixel in the same LED unit.

Further, first the driving current supplied to LEDs corresponding to each of color tones R, G, B respectively is corrected based on the white balance correcting data and the plate luminance correcting data in the current supplying portion 14, then the driving current corresponding to each LED is corrected individually in the luminance correcting portion 13 and the chromaticity correcting portion 11. So that each kind of correcting such as white balance correcting, plate luminance correcting, pixel luminance correcting, and pixel chromaticity correcting can be performed individually.

Next, the chromaticity correcting portion 11 will be described. In the chromaticity correcting portion 11, a predetermined part of the driving current supplied to the LED corresponding to each color tone is distributed to the driving current corresponding to the other color tones based on the chromaticity correcting data stored in each pixel precedently. Namely, the driving current corresponding to R is distributed to the LEDs corresponding to G, B composing the same pixel, the driving current corresponding to G is distributed to the LEDs corresponding to B, R composing the same pixel, the driving current corresponding to B is distributed to the LEDs corresponding to R, G composing the same pixel, respectively. The predetermined part of the driving current to be distributed is defined with setting a distributing ratio as the chromaticity correcting data, for example. To correct chromaticity of the LED corresponding to one color tone in the respective pixels driven by predetermined driving currents into the reference chromaticity, the chromaticity correcting data is set as the distributing ratio of the driving current of the LEDs corresponding to other color tones precedently. The chromaticity correcting data is stored in each color tone of the respective pixel in the storing portion.

Here, the distributing ratio corresponding to G, B against R are r_{G}, r_{B}, the distributing ratio corresponding to B, R against G are g_{B}, g_{R}, the distributing ratio corresponding to R, G against B are b_{R}, b_{G}, respectively. Amount of electric charges supplied to the light emitting elements L_{R}, L_{G}, L_{B} based on the image data D_{R}, D_{G}, D_{B} are Q_{R}, Q_{G}, Q_{B}. Amount of supplied electric charges corresponding to the other light emitting elements are Q′_{R}, Q′_{G}, Q′_{B}. Total amount of electric charges Q″_{R}, Q″_{G}, Q″_{B} supplied to the light emitting elements L_{R}, L_{G}, L_{B} in a pixel are represented by the following formula

$$[ \begin{matrix}{Q}_{R}^{″} \\ {Q}_{G}^{″} \\ {Q}_{B}^{″}\end{matrix} ] = [ \begin{matrix}{Q}_{R} + {Q}_{R}^{′} \\ {Q}_{G} + {Q}_{G}^{′} \\ {Q}_{B} + {Q}_{B}^{′}\end{matrix} ] = [ \begin{matrix}1 & {g}_{R} & {b}_{R} \\ {r}_{G} & 1 & {b}_{G} \\ {r}_{B} & {g}_{B} & 1\end{matrix} ] [ \begin{matrix}{Q}_{R} \\ {Q}_{G} \\ {Q}_{B}\end{matrix} ] \qquad [ Formula 2 ]$$

Controlling the above amount of electric charges can control amount of light emission of the light emitting elements. Here, the driving current supplied from the current supplying portion 14 to light emitting elements L_{R}, L_{G}, L_{B} in a pixel are I_{R}, I_{G}, I_{B}, respectively. Driving period representing gradation based on the image data D_{R}, D_{G}, D_{B} are T_{R}, T_{G}, T_{B}, respectively. Amount of electric charges Q_{R}, Q_{G}, Q_{B} and Q′_{R}, Q′_{G}, Q′_{B} are represented by the following formulas

Qᵢ=IᵢTᵢ (i=R,G,B)

Q′ᵢ=Σ_{k≠i)}iₖIₖTₖ(iₖ=r_{G},r_{B},g_{B},g_{R},b_{R},b_{G}) [Formula 3]

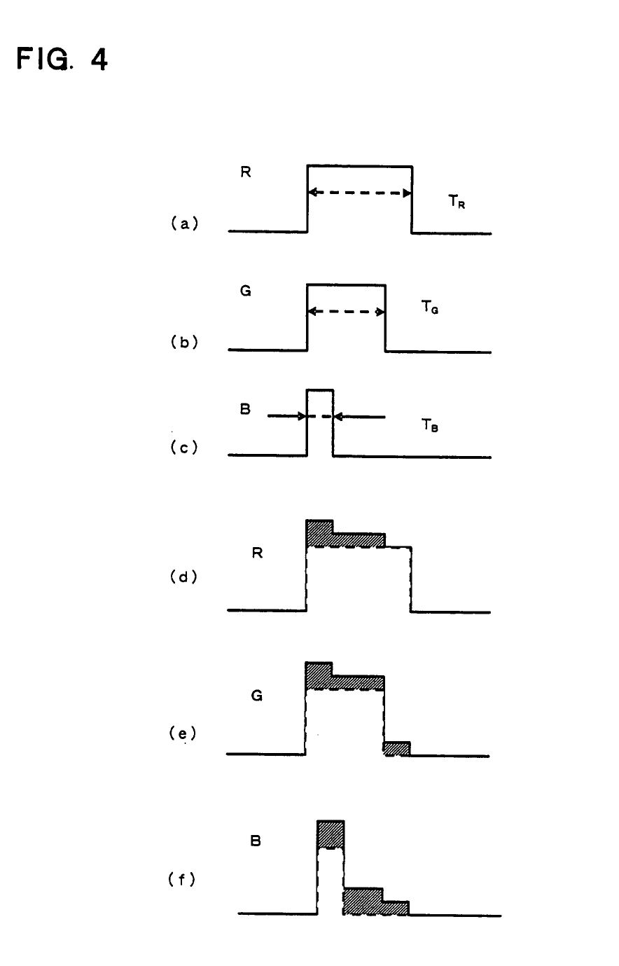

This manner is described with FIG. 4. For example, when pulse driving currents corresponding to R, G, B in a pixel supplied from the driving period control portion 12 based on the image data D_{R}, D_{G}, D_{B} are shown (a), (b), (c) in FIG. 4 respectively, pulse driving currents, which are corrected in the chromaticity correcting portion 11 and then finally supplied to each LED in the pixel corresponding to R, G, B, are shown (d), (e), (f) in FIG. 4 respectively. In this case, amount of electric charges Q″_{R}, Q″_{G}, Q″_{B} supplied to respective LEDs in the pixel corresponding to R, G, B are shown areas enclosed by solid lines. Namely, in this example, light emission of the light emitting element L_{B} corresponding to B is performed not only in the driving period T_{B} based on the image data D_{B}, but also in the driving period T_{R}, T_{G} of the other light emitting elements L_{R}, L_{G} based on the image data D_{R}, D_{G}. In other words, amount of a electric charge Q″ᵢ finally supplied is amount of electric charge, which is added amount of a electric charge for itself Qᵢ with amount of a electric charge Q′ᵢ filled with diagonal lines.

In the above-mentioned example, though distributed amount of an electric charge Q′ₖ (k≠i) is added during a driving period Tᵢ based on the image data Dᵢ corresponding to the other color tones, the distributed amount of electric charge Q′ᵢ may be added during a driving period shorter than the driving period Tᵢ based on the image data Dᵢ. Because the distributed amount of electric charge Q′ᵢ is not much compared with the amount of a electric charge for itself, so that amount of a driving current kᵢIi to be distributed is required to control with high-accuracy during the driving period Tᵢ based on the image data Dᵢ.

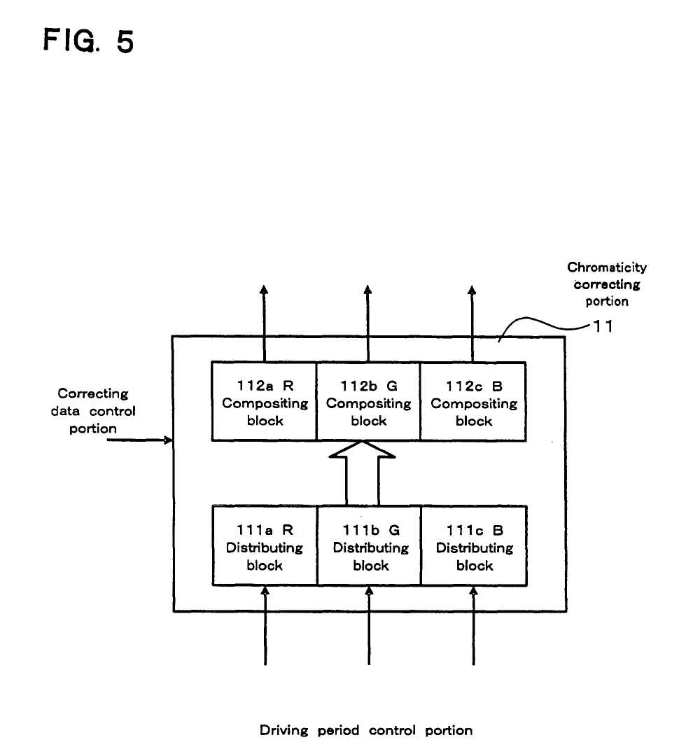

FIG. 5 is a view schematically showing the chromaticity correcting portion 11. The chromaticity correcting portion 11 includes distributing blocks 111a, b, c and compositing blocks 112a, b, c corresponding to R, G, B respectively. Each of the distributing blocks 111a, b, c includes a chromaticity correcting data storing portion storing the distributing ratio, and distributes the pulse driving current supplied from the driving period control portion 12 to each of the compsiting portions 112a, b, c based on the stored chromaticity correcting data. The pulse driving current distributed from the respective distributing blocks 111a, b, c is composited with the amount of driving currents for themselves in the compositing blocks 112a, b, c corresponding to R, G, B. Each of the compsited pulse driving currents is supplied to the LED to be driven. Although the chromaticity correcting data storing portion can store the distributing ratios corresponding to all pixels, preferably includes one pixel or one line of the chromaticity correcting data storing memory with rewriting data thereof pixel by pixel or line by line dynamically. Because it can reduce amount of the memory. To achieve this constitution, the chromaticity correcting portion storing portion of the chromaticity correcting portion 11 can be chromaticity correcting data temporary memory composed of a resister or a RAM or the like, for example.

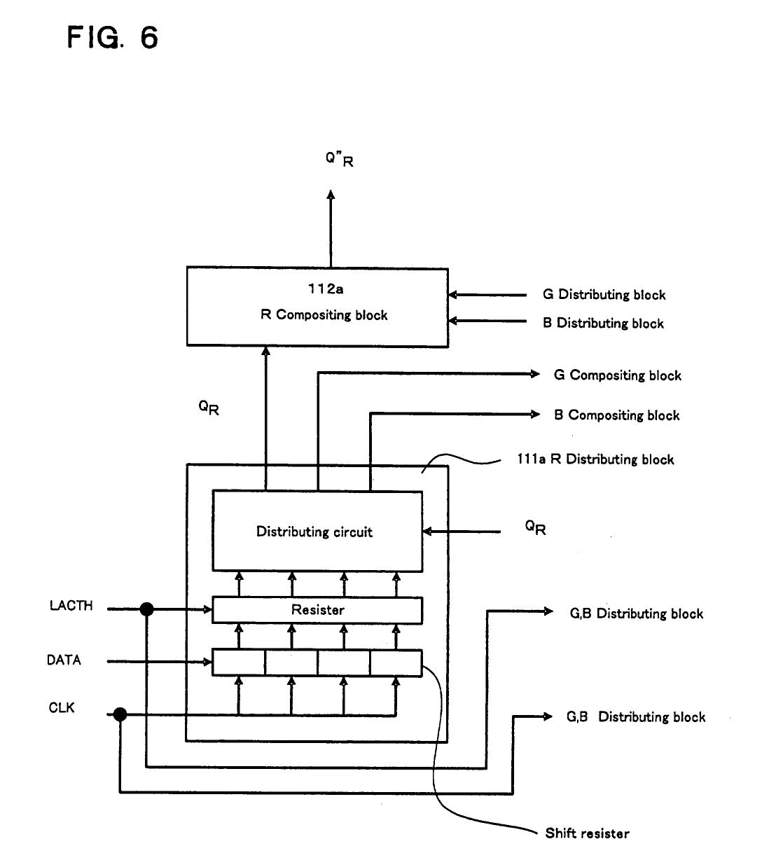

FIG. 6 shows an example of the chromaticity correcting data storing portion composed of one line of one shift resister and similarly one line of one resister. FIG. 6 shows only a part corresponding to R, and is a view schematically showing the R distributing portion 111a and the R compositing portion 112a. The resister in the R distributing portion 111a retains chromaticity correcting data r_{G}, r_{B} of a line to be driven. A distributing circuit distributes the pulse driving currents, which are distributed to the LEDs corresponding to G and B, to the G and B compositing blocks 112b, c (not shown in FIG. 6) based on the chromaticity correcting data r_{G}, r_{B} retained in the resister. The R compositing block 112a composites pulse driving currents, which are distributed from the G and B distributing blocks 111b, c to the R of LED similarly, with the driving current for itself, which is supplied from the driving period control portion 12. Then the R compositing block 112a it supplies to the R of LED to be driven.

The chromaticity correcting data for the next line is input to the shift resister in each of r_{G}, r_{B} through chromaticity correcting data line DATA with shifting by a clock signal CLK one after another. Subsequently, corresponding to a change timing to the next line, the chromaticity correcting data is transferred into the resister by a latch signal LATCH. Then the chromaticity correcting data corresponding to the next line is retained in the resister. Thus, inputting the chromaticity correcting data with shifting by the shift resister one after another can simplify a constitution of the circuit. In this embodiment, though the chromaticity correcting data is input in parallel in each of r_{G}, r_{B}, the shift resister corresponding to the chromaticity correcting data r_{G}, r_{B} may be connected in serial.

[Embodiment 2]

Next, another embodiment of the invention, an embodiment 2, will be described.

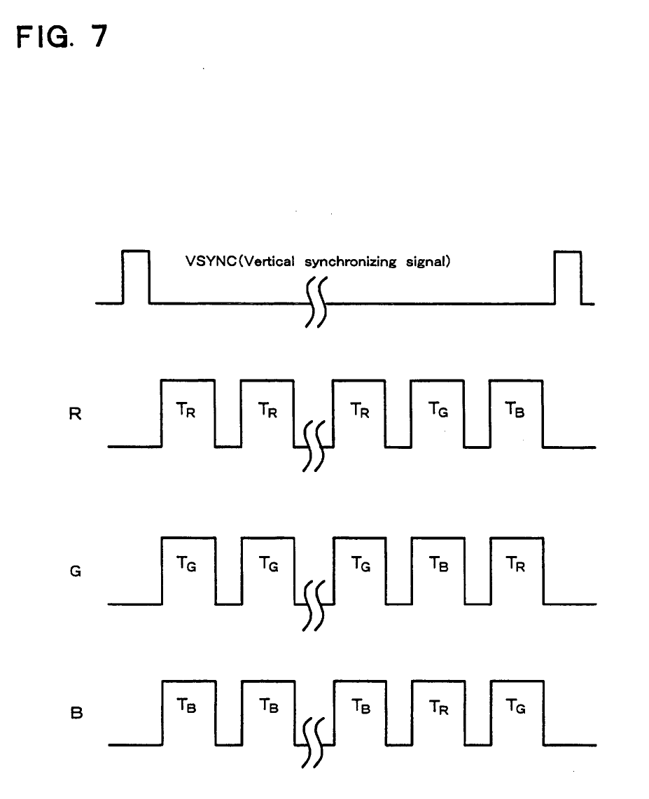

FIG. 7 shows a pulse driving current supplied to each of the light emitting elements L_{R}, L_{G}, L_{B} in one image frame period in the embodiment 2. In the specification, the image frame is defined a period for displaying one frame of image data, one image frame period is defined as a period between two VSYNC pulses (vertical synchronizing signals), which are frame signals, shown at top of a chart in FIG. 7. Here, the image frame period of one image frame corresponding to one color tone in a video signal is divided into divided image frame periods; and a driving pulse, which is performed pulse-width-control based on the image data, is allocated into each of the divided image frame periods. Some of the divided image frame periods are set as a predetermined periods. The driving pulses of the predetermined periods are supplied to the light emitting elements corresponding to the other color tones, so as to control amount of light emission. Here, width of each area enclosed by solid lines is regarded as setting each of the driving periods T_{R}, T_{G}, T_{B} based on the image data D_{R}, D_{G}, D_{B}, for ease of simplifying the figure. Additionally, the driving period control portion 12 employs high-frequency reference clock for representing gradation during such divided image frame period.

The pulse driving current of the light emitting element L_{R} corresponding to R will be described, as an example. The predetermined periods of the divided image frames are replaced by the pulse driving currents, which are supplied to the light emitting elements L_{G}, L_{B}, then they are supplied to the light emitting element L_{R}. In FIG. 7, the two of right end of the divided image periods in the image frame period are replaced each other. Thus, amount of light emission A′_{R} based on amount of light emission A_{G}, A_{B} of light emitting elements L_{G}, L_{B} corresponding to the other color tones can be added to amount of light emission A_{R} of the light emitting element L_{R} corresponding to R during one image frame of the driving period. In this case, amount of light emission corresponding to a dispersion of each light emitting element can be added by controlling number of pulse driving currents to be replaced, or by controlling amount of a driving current.

In the embodiment 2, data according to number of pulse driving currents to be replaced, or data according to amount of a driving current are stored in chromaticity correcting data storing portion of each of distributing blocks 111a, b, c, similarly to the embodiment 1. The distributing circuit generates the pulse driving current corresponding to chromaticity correcting data, and supplies to each of the compositing blocks 112a, b, c properly.

[Embodiment 3]

Further, an embodiment 3 will be described below.

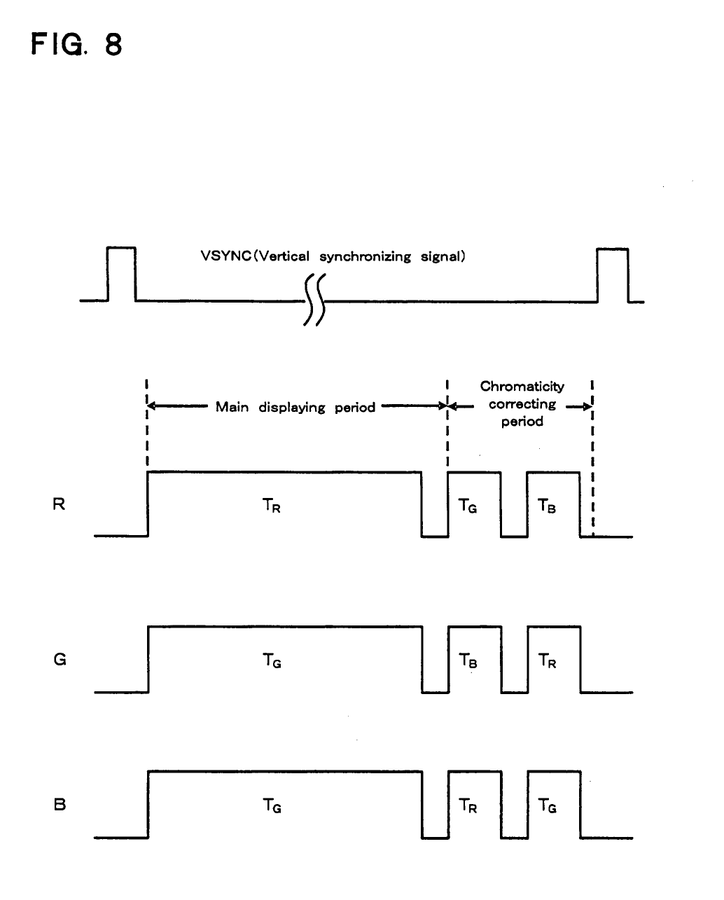

FIG. 8 is a view showing an example of a pulse driving current supplied to each of the light emitting elements L_{R}, L_{G}, L_{B} in the embodiment 3. Here, the image frame period of one image frame corresponding to one color tone in a video signal is divided into three driving periods corresponding to the image frame periods. A pulse driving current for the light emitting element corresponding to the color tone is supplied during one of the divided driving period as main displaying period. Pulse driving currents for the other color tones are supplied to control adding amount of light emission A″ₖ during the other two divide driving periods as chromaticity correcting periods. Here, each area enclosed by solid lines is regarded as setting each of the driving periods T_{R}, T_{G}, T_{B} based on the image data D_{R}, D_{G}, D_{B}. In this example, the reference clock of pulse driving currents based on the image data D_{R}, D_{G}, D_{B} corresponding to the light emitting elements L_{R}, L_{G}, L_{B} is set as its width longer so as to set the driving periods long sufficiently, while the reference clock of pulse driving currents for the other color tones is set as its width shorter so as to set the driving periods short. Thus, amount of light emission based on amount of light emission corresponding to one of color tones can be added to amount of light emission corresponding to the other color tones during one image frame of driving period. In this case, amount of light emission corresponding to a dispersion of each light emitting element can be added by controlling widths of reference clocks, that is the ratio of frequency of the reference clocks, or by controlling amount of a driving current.

In the embodiment 3, the current period control portion 12 includes the chromaticity correcting data storing portion, and controls the driving periods based on the data according to the ratio of frequency of the reference clocks, which is the chromaticity correcting data. The chromaticity correcting portion 11 replaces each pulse current to the light emitting element to be supplied corresponding to pulse driving current replacing timing.

Although chromaticity correcting is performed for light emitting elements corresponding to each of R, G, B in the embodiments 1 through 3 described above, the chromaticity correcting portion may distribute a predetermined part of the driving currents, which are supplied to at least one of the plurality of color tones, to the light emitting elements corresponding to at least one of the other color tones.

In these embodiments, it is described that the correcting data storing portion 32 is arranged in the LED unit, and that the chromaticity correcting portion 11 is direct-controlled based on the chromaticity correcting data stored in the correcting data storing portion 32. Besides, the image displaying control method of the invention can correct display data based on information of dispersion of luminance and chromaticity corresponding to the light emitting elements with adding more bits to the display data for correcting by an image signal processing method. In this case, the signal processing can be complicated, therefore it may not easy to achieve both gradation control of high-resolution and high-precision luminance correcting or chromaticity correction. Further, in a large-scaled display apparatus composed of divided units such as LED display units, when the correcting data is stored signal processing portion controlling the display data collectively, the light emitting elements and data according to a dispersion of the light emitting element are separated each other. So that it is not easy to manage the data at the maintenance such as replacing a part of the units. Accordingly, in the image displaying control method of the LED units, chromaticity correcting is preferably direct-controlled.

[A Chromaticity Correcting Method of an Image Display Apparatus]

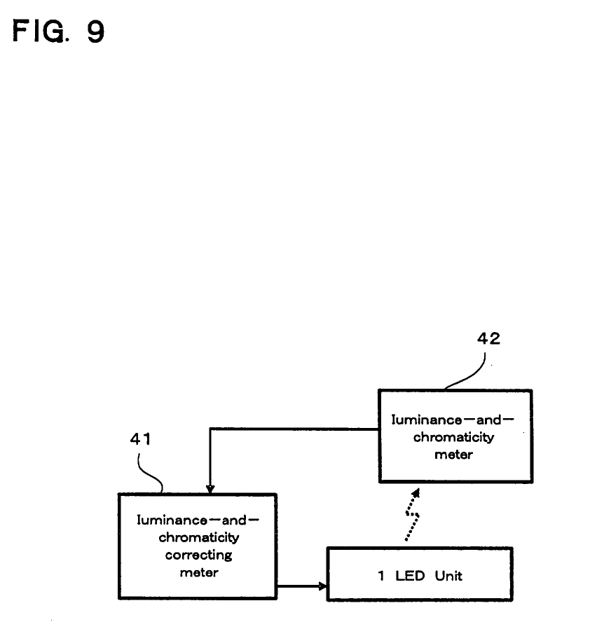

Next, a control method of an image display apparatus of the invention will be described as an embodiment 4. FIG. 9 is a view schematically showing a chromaticity correcting system used in the control method of the image display apparatus of the invention. The system shown in this figure includes an LED unit 1, a luminance-and-chromaticity correcting apparatus 41 connected with the LED unit 1, and a luminance-and-chromaticity meter 42 connected with the luminance-and-chromaticity correcting apparatus 41 to detect intensity of light emission of the LED unit 1.

In the chromaticity correcting system, the luminance-and-chromaticity correcting apparatus 41 performs lighting-control of each dot of the LED unit 1. The detecting device for intensity of light emission with photo detectors corresponding to a plurality of color tones as the luminance-and-chromaticity meter 42 is arranged and connected so as to receive light emission from the LED unit 1 into the photo detectors. The luminance-and-chromaticity correcting apparatus 41 reads data according to luminance and chromaticity of each pixel of the LED unit 1 by the luminance-and-chromaticity meter 42, and calculates an average of each of whole LED units 1. Subsequently, a driving current supplied from the current supplying portion 14 is corrected so as to agree each average with a predetermined reference white balance and plate luminance, in each of R, G, B. A correcting value of each of R, G, B in each pixel is calculated from the reference values of luminance and chromaticity by a determinant. Also, a dot correcting value and a chromaticity correcting value are calculated simultaneously. The correcting data according to the control is stored as the white balance correcting data and plate luminance correcting data into the correcting data storing portion 32 via the communicating portion 33 in the LED unit 1 shown in FIG. 3.

Next, the luminance-and-chromaticity correcting apparatus 41 reads luminance data of each dot of the LED unit 1, which is driven in a condition of a driving current corrected at the set value. Then the luminance correcting portion 13 of FIG. 3 controls a driving current in each dot, so as to agree luminance of each dot with the predetermined reference value. The pixel luminance correcting data according to this control is stored as the pixel luminance correcting data into the correcting data storing portion 32 via the communicating portion 33 in the LED unit 1.

Further, the LED corresponding to each color tones in each pixel of the LED unit 1 is driven in the chromaticity correcting portion 11 by the driving current corrected corresponding to each of R, G, B in each pixel without distributing. Then, each chromaticity is calculated from the intensity of light emission at the photo detector corresponding to each of the plurality of color tones in each pixel. Furthermore, each of the calculated chromaticity of the light emitting element corresponding to each color tone in each pixel is compared with the reference chromaticity. The luminance-and-chromaticity correcting apparatus controls the distributed pulse driving currents in the chromaticity correcting portion 11 of the LED unit 1 based on deference of chromaticity between the calculated chromaticity in each pixel and the reference chromaticity, so as to correct chromaticity of the LED corresponding to each color tone. The chromaticity correcting data according to the driving current, which is distributed from the driving current of the LED corresponding to each color tone to the driving current of the LEDs corresponding to the other color tones, is stored as the chromaticity correcting data in each pixel into the correcting data storing portion 32 via the communicating portion 33 in the LED unit 1. Besides, the luminance correcting value and the chromaticity correcting value may be calculated simultaneously by calculating the correcting value of each of R, G, B in each pixel with determinant from the reference values of luminance and chromaticity.

The correcting method is one example to describe the system, it is needless to say that repeating the process in several times can make the correcting value of convergence more accurate. Further, the correcting process can adjust in reverse sequence such as starting from the chromaticity correcting, to the pixel luminance correcting, the plate luminance correcting, the white balance adjusting, and it is also effective. Furthermore, though the method is described to store various correcting data separately such as the chromaticity correcting data, the pixel correcting data, the plate luminance correcting data, and the white balance correcting data in the embodiment, the correcting data can be store in each pixel with collective processing.

[Embodiment 5]

Furthermore, an image display apparatus of an embodiment 5 of the invention will be described. In this embodiment, a spontaneous LED composing a pixel is performed luminance correcting with supplying a main current, and chromaticity correcting is performed simultaneously with supplying the other LEDs composing the pixel simultaneously.

Namely, in a constitution connecting three light emitting elements with a driving circuit, to correct color tones, that is a dispersion of chromaticity, of the light emitting elements corresponding to each colors, the light emitting elements corresponding to the color tone to be performed chromaticity correcting are performed chromaticity correcting with the lighting light emitting elements corresponding to the other two colors in a small amount, in the invention. For example, when correcting red, the light emitting elements corresponding to red are performed chromaticity correcting with adding correcting currents for the light emitting elements corresponding to green and/or blue. Similarly, chromaticity correcting of green adds the correcting currents for red, blue, and chromaticity correcting of blue adds the correcting currents for red, green in time-sharing.

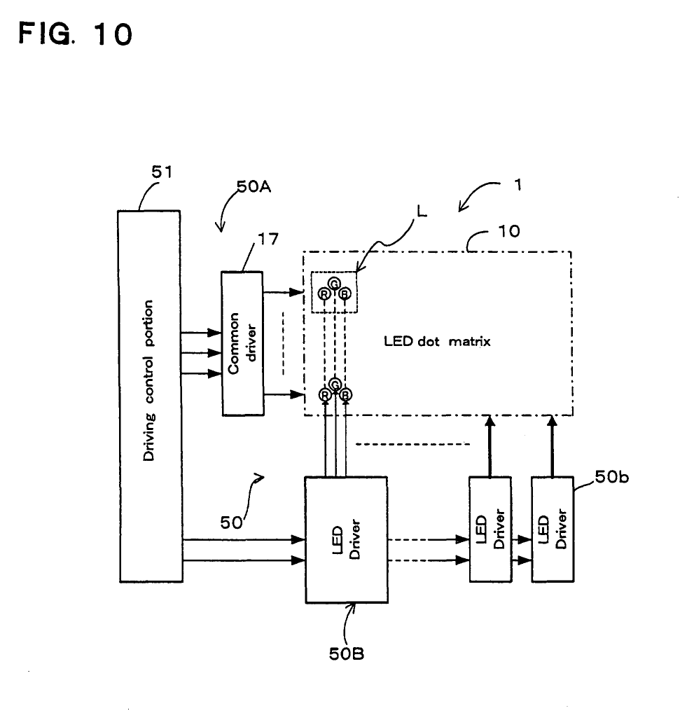

FIG. 10 is a block diagram schematically showing the constitution of the LED display unit according to the image display apparatus of the embodiment 5. The image apparatus of FIG. 10 includes a display portion 10 aligning a plurality of LEDs in each pixel in a matrix shape, a driving portion 50 driving the LEDs in the display portion 10, a driving control portion 51 transmitting various control data to the driving portion 50. The driving portion 50 is composed of a vertical driving portion 50A and a horizontal driving portion 50B. In this case, the vertical driving portion 50A is a common driver 17, the horizontal driving portion 50B is composed of LED drivers 50b.

In the image display apparatus of FIG. 10, the driving control portion 51 transmits image data, luminance data, chromaticity correcting data and so on to the driving portion 50. This image display performs dynamic driving directly. The driving control portion 51 controls the common driver 17, which is the vertical driving portion 50A. The common driver 17 performs power supply switching for the LEDs connected with each common line on the LED dot matrix, which is display portion 10.

The plurality of LED drivers 50b, which composes the horizontal driving portion 50B, are connected, and supply currents to the LEDs connected with lines selected by the common driver 17.

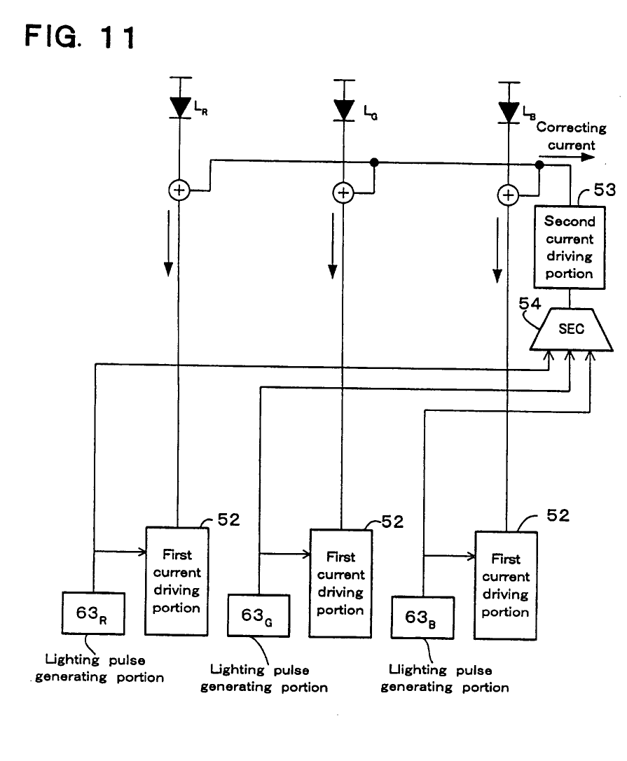

FIG. 11 shows an example of a circuit constitution of the image display apparatus in the embodiment 5. The horizontal driving portion shown in the figure includes: the LEDs L_{R}, L_{G}, L_{B}, which are light emitting elements; three first current driving portions 52, which are connected with these respective LEDs, capable to perform driving control individually; a second current driving portion 53 supplying the correcting currents to each LED; and three lighting pulse generating portions 63_{R}, 63_{G}, 63_{B}, which are connected with the first current driving portions 52 and the second current driving portion 53, inputting lighting pulses. The lighting pulse generating portion 63 corresponding to each LED is connected with the second current driving portion 53 via a selector 54. The selector 54 is a selector selecting an input from each lighting pulse generating portion 63 for outputting to the second current driving portion 53. Therefore it is possible to control the correcting current to each LED by only one second current driving portion 53 in time-sharing. In the circuit of this constitution, the first current driving portion 52 performs luminance correcting of each LED based on the lighting pulse. The second current driving portion 53 supplies the correcting current based on the lighting pulse selected by the selector 54, so as to perform chromaticity correcting.

[Embodiment 6]

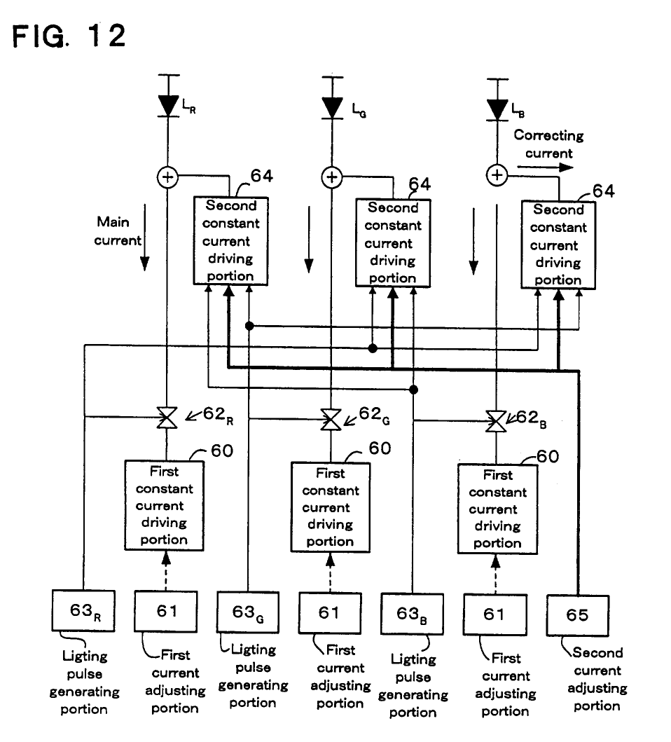

Furthermore, FIG. 12 is a block diagram showing a constitution of an image display apparatus of an embodiment 6 according to the invention. The first driving current control portion 52 shown in the figure includes: a plurality of first constant current driving portions 60, which are connected with these respective light emitting elements to supply the main current based on the image data, capable to perform driving control in each light emitting element individually; first current adjusting portions 61 connected with the first constant current driving portions 60 to adjust output currents of the first constant current driving portions 60; and main current switches 62 connected serially between the first constant current driving portions 60 and the light emitting elements to control current supplies for light emitting elements.

The first constant current driving portions 60 shown in FIG. 12 are connected with the respective LEDs via the main current switches 62_{R}, 62_{G}, 62_{B} respectively. Each of the lighting pulse generating portions 63_{R}, 63_{G}, 63_{B} connected with each main current switch 62 performs ON/OFF control of each main current switch 62. The lighting pulse generating portions 63 generate lighting pulses with pulse width modulation based on the image data received from the driving control portion 51. The LPGPs 63 add these lighting pulses as ON/OFF signals of the respective main current switches 62 to perform driving control of the main currents in the respective first constant current driving portions 60.

Besides, though the main current switches 62 shown in FIG. 12 are connected serially between the first constant current driving portions 60 and the light emitting elements, their connections are not limited these connections. For example, the main current switch 62 can be connected between the first constant current driving portion 60 and the first current adjusting portion 61. In addition, the PWM control based on the lighting pulse from the lighting pulse generating portion 63 is not limited only to be performed by the main current switch 62, but also can be performed by the first constant current driving portion 60 or the first current adjusting portion 61.

Additionally, the driving circuit of FIG. 12 further includes second constant current driving portions 64, and second current adjusting portions 65 connected with the second constant current driving portions 64, to perform chromaticity correcting of the respective LEDs. In this constitution, the first constant current driving portion 60 performs constant current control of the main current controlling luminance of each of LEDs, and the second constant current driving portion 64 adds the correcting current, which performs chromaticity correcting of LEDs corresponding to the other color tones, to the LED simultaneously. The second current control portion 65, which is further provided for the second constant current driving portion 64, adjusts a value of the correcting current to be added.

The first current adjusting portion 61 and the second current adjusting portion 65 can be composed of D/A converters for current adjusting. Namely, including one circuit of the D/A converter (DAC) for luminance correcting and the D/A converter (DAC) for chromaticity correcting per pixel respectively can perform control in each pixel.

The second current control portion 53 can be provided per each of color tones R, G, B to perform chromaticity correcting of each of the color tones simultaneously. Also, the second current control portion 53 can commonly perform chromaticity correcting of each of the color tones in time-sharing. In FIG. 12, one second current adjusting portion 65 is connected with the three second constant current driving portions 64 in parallel. Therefore, number of the second current adjusting portion 65 to be required to supply the correcting current can be reduced. Besides, plurality of constant current circuits to be required to supply the correcting current can be provided to supply a plurality of chromaticity correcting currents simultaneously, such as the second current adjusting portions are provided to connected with the respective second constant current driving portions.

The second current adjusting portion 65 determines a value of output current, then the second constant current driving portion adds the output current as the correcting current for chromaticity correcting to the main current of each color tone to perform chromaticity correcting. The second current adjusting portion 65 adjusts the value of the current to be added in the second constant current driving portion 64. For example, when correcting R (red), the lighting pulse signal generated in the lighting pulse generating portion 63 for red drives the second constant current driving portions 64 for G (green) and B (blue) respectively. Then, chromaticity correcting for red is performed with lighting by supplying the main current to the LED corresponding to red and the correcting currents to the LEDs corresponding to green, blue. Chromaticity correcting of the other color tones is also performed similarly. For example, in chromaticity correcting of green, the correcting currents of red, blue are added; in chromaticity correcting of blue, the correcting currents of red, green are added.

Therefore, when lighting LEDs corresponding to R, G, B as one pixel, the main current of each LED is added with the correcting currents corresponding to the other two color tones each other. For example, the main current for lighting red, and the correcting currents for chromaticity correcting of green and blue are applied to the red LED. The main current and the correcting current for chromaticity correcting are composited in each second current driving portions.

The image display apparatus of the embodiment 6 described above includes the following elements:

(1) the first current adjusting portions 61 controls the main currents of each color tone; the gradation pulse width of the lighting pulse generating portion 63 is determined based on the gradation data received from the driving control portion 51, and the main current is supplied from the first constant current driving portion 60 to the LED during the pulse valid period,

(2) further, the image display apparatus of the embodiment 5 inputs the lighting pulse, which is generated in the pulse generating portion 63, according to the LED to be corrected its chromaticity as the driving current control signal into the second constant current driving portions 64 of the other two color tones; and the predetermined correcting current for chromaticity correcting is added to the main current of the LED to be corrected based on the second current adjusting portion 65.

Thus, due to these features in the image display apparatus of the embodiment 6, the first constant driving portion 60 and the first current adjusting portion 61 in the driving portion 50 of the LED corresponding to each of red, green blue can adjust the main current to output, and the second constant current driving portion 64 and the second current adjusting portion 65 can perform driving control of the correcting current to be added to the main current. So that it is possible to make a dispersion of the LEDs uniform by chromaticity correcting of the LED corresponding to each color tone.

[Embodiment 7]

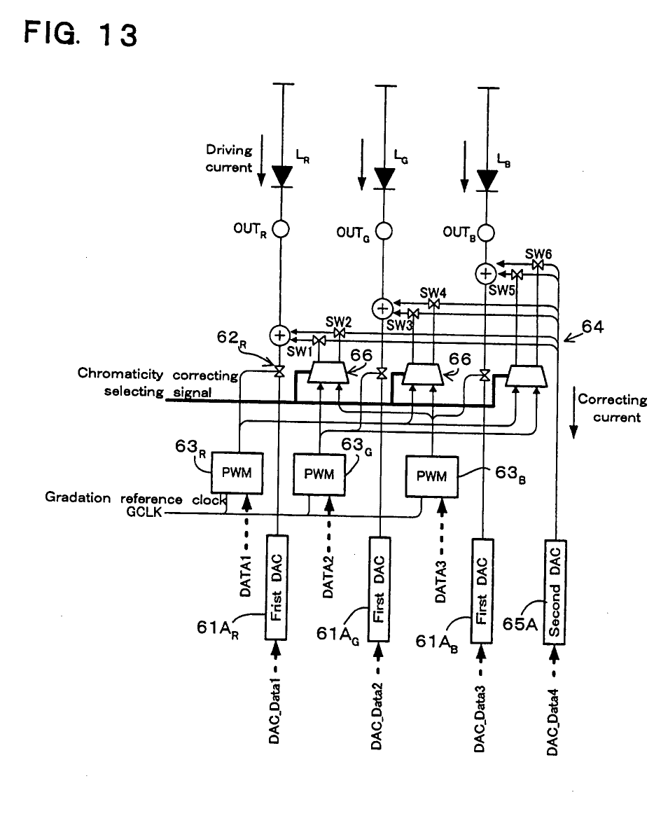

Next, FIG. 13 shows an image apparatus according to an embodiment 7 of the invention. A constant current circuit of FIG. 13 includes: the LEDs L_{R}, L_{G}, L_{B} corresponding to R, G, B; output portions OUT_{R}, OUT_{G}, OUT_{B} connected with the respective LEDs; lighting pulse generating portions 63_{R}, 63_{G}, 63_{B}; first current adjusting D/A converters 61A_{R}, 61A_{G}, 61A_{B}, which are the first current adjusting portions; a second current adjusting D/A converters 65A, which is the second current adjusting portion; correcting current switches SW 1 to 6 and switch control portions 66, which compose the second constant current driving portion 64. The embodied constitution of the image display apparatus according to the embodiment 7 will be described below, with reference to the constant current driving circuit for chromaticity correcting shown in FIG. 13.

In the constant current driving circuit shown in FIG. 13, the output portion, which controls one pixel, is composed of the three output portions OUT_{R}, OUT_{G}, OUT_{B} corresponding to R, G, B respectively. Each output portion can control constant current driving individually. In the embodiment, luminance of each LED is adjusted with gradation control by pulse width modulation. Specifically, gradation reference clock (GCLK) is input into the lighting pulse generating portions 63_{R}, 63_{G}, 63_{B}. Lighting periods are controlled with pulse width modulation based on gradation data (DATA 1 to 3). The first current adjusting D/A converters 61A_{R}, 61A_{G}, 61A_{B} determine the main currents to be supplied to the respective output portions based on the lighting pulses, and drive the respective output portions OUT_{R}, OUT_{G}, OUT_{B}. The first current adjusting D/A converters 61A_{R}, 61A_{G}, 61A_{B} and the second current adjusting D/A converters 65A are controlled by inputting control data DAC_Data 1 to 4. Here, the control data DAC_Data 1 to 3 can be the white balance data, the plate luminance correcting data, the pixel luminance correcting data and so on, while the control data DAC_Data 4 is the chromaticity control data.

In this embodiment, to correct LED corresponding to spontaneous color tone, the correcting currents are added LEDs corresponding to the other two color tones during the same lighting period, so as to adjust the LEDs to predetermined chromaticity. Namely, to correct one color tone, the correcting currents for the other two color tones are required to be added, so that six kinds of correcting currents are required to be added in three color tones. The constant current driving circuit shown in FIG. 13 includes the correcting current switches SW 1 to 6. Each correcting current switches SW is turned ON based on a chromaticity correcting selecting signal in time-sharing.

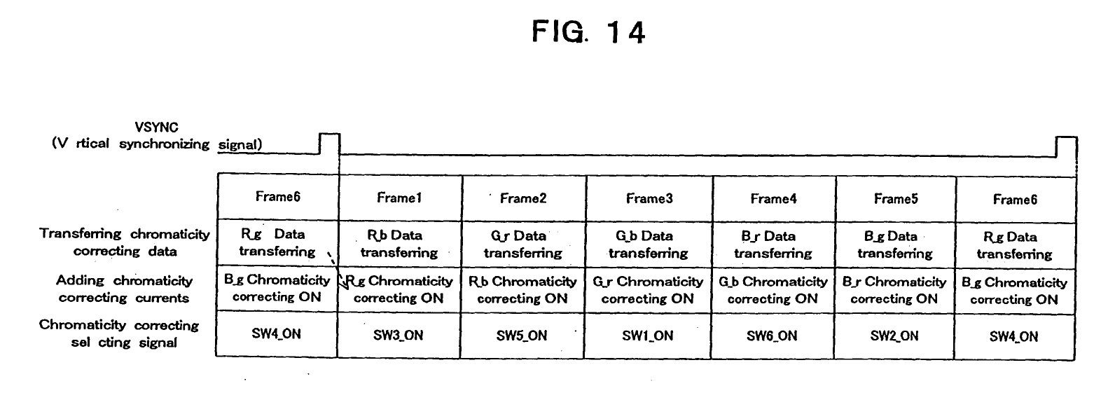

FIG. 14 is an example of a time chart for a chromaticity correcting operation. In the operation, one image frame, which is defined the VSYNC (vertical synchronizing signal) denoting start of the image frame as a frame signal, is divided into six image transferring frames (Frame). The image data is transferred in the image transferring frame 1 to 6 to perform an image display operation. Dividing one frame into several image transferring frames, and performing lighting display several times based on the same image data in each image transferring frame, so that the flicker can be restrained.

Chromaticity correcting corresponding to each color tone is performed in each six-divided image transferring frame. The value of each chromaticity correcting current corresponding to the LED to be correct is transferred as the chromaticity correcting current data in a previous image transferring frame. In other words, each chromaticity correcting current data is transferred to the second current adjusting D/A converter 65A in the previous image transferring frame, then the correcting current is added to the LED to be performed chromaticity correcting in a next image transferring frame by turning the correcting current switch SW into ON. The correcting current switch SW performs adding control of the correcting current based on the chromaticity correcting selecting signal in time-sharing. The correcting current is added from the second current adjusting D/A converter 65A to the LEDs, which are not the LED to be corrected, via the correcting current switches SW. Thus, each image transferring frame shown in FIG. 14 includes: a step transferring the chromaticity correcting current data in the previous image transferring frame; a step supplying the chromaticity correcting current based on the chromaticity correcting current data transferred in the previous image transferring frame by the second current adjusting D/A converter 65A; and a step turning the correcting current switches SW corresponding to correcting ON based on the chromaticity correcting selecting signal by the switch control portion 66.

For example, R_g chromaticity correcting data denotes the chromaticity correcting current data for lighting G (green) to correct the LED corresponding to R (red). The R_g chromaticity correcting data is transferred in an image transferring frame 6, then the data is retained in the next image transferring frame 1 so as the chromaticity correcting current to be added. In the next image transferring frame 1, the correcting current switch SW3 is turned ON by selecting of the chromaticity correcting selecting signal, so that the correcting current is supplied based on the R_g chromaticity correcting data from the second current adjusting D/A converter 65A, and the lighting pulse generating portion 63 performs PWM control. Thus, the chromaticity correcting current of G is added during lighting the LED corresponding to R. Similar processes are performed the image transferring frames 1 to 6, so that chromaticity correcting of the LEDs corresponding to all color tones is performed with switching the correcting current switches SW 1 to 6 in time-sharing during one image frame period.

Here, though the embodiment shows to supply the correcting currents for chromaticity correcting of LEDs in each image transferring frame, number of the image transferring frames, in which are performed correcting current supply, can be set properly, also it can set properly which image transferring frames are performed correcting current supply. Number of the divided image transferring frames corresponding to one image frame can be determined in view of preventing flicker of the image display apparatus. Also, the correcting current depends on number of color tones of the LEDs used therein, and number of the LEDs to be lighten for the correcting. For example, when number of the image transferring frames is set in eight, and six of the image transferring frames can be set to be performed correcting current supply.

As described above, the image display apparatus and the control method thereof can make chromaticity of each pixel uniform despite a dispersion of chromaticity of light emitting elements such as LEDs.

Especially, providing the correcting data storing portion in the image display unit to control the chromaticity correcting portion based on the chromaticity correcting data stored in the correcting data storing portion directly, so that the units with uniform luminance and chromaticity can be manufactured. Therefore, it is possible to provide image display with high uniformity not only among the units, but also in the unit.

Further, the chromaticity correcting portion can be integrated in a IC chip easily with the current supplying portion, the luminance correcting portion, the driving period control portion or the like. Therefore, it is possible to make the image display both downsized and cost-reduction. Furthermore, when a plurality of the image display units compose the large-scale display, it has a merit to make maintenance, such as replacing a part of the image display units, easier that each image display unit is furnished with a function of correcting. In addition, an external image data control circuit supplying the image data to the image display apparatus is only required a function of displaying images on the uniform display without considering a dispersion of the light emitting elements. Therefore, a signal process capable to display a high quality image is achieved easily.

Thus, the image display apparatus and the control method thereof have a merit to achieve cost-reduction of manufacturing by using low-cost LEDs with a dispersion of their characteristics, and also to provide the high quality image display apparatus with reproducibility of the same data.

Furthermore, in the image display apparatus according to the invention, one current adjusting portion for chromaticity correcting is provided for each pixel to add the correcting current for chromaticity correcting corresponding to all color tones with switching by ON/OFF control of the correcting current switches. Therefore, chromaticity correcting corresponding to all color tones is performed in one image of image frame period. This constitution can achieve chromaticity correcting corresponding to all color tones without employing several current adjusting D/A converting circuits etc. Especially, the current adjusting D/A converter assembled with resistors etc. occupies enough space. The invention can control chromaticity correcting of one pixel of the light emitting elements by one circuit, not to provide the second current adjusting D/A converters for respective light emitting elements individually. So that it has a merit to reduce number of parts for a circuit constitution in low-cost, and to down size the circuit for downsizing the apparatus.

### INDUSTRIAL APPLICABILITY

As has been discussed, the image display apparatus and the control method thereof have advantageous in the image display apparatus such as the LED display and the control method thereof. Especially, the invention has advantageous to provide the image display apparatus, which corrects a dispersion of chromaticity of the light emitting elements to make color tone in each pixel uniform, with well-reproducibility.

1. An image display apparatus comprising
light emitting elements corresponding to a plurality of color tones disposed in each pixel, wherein,
a main current for luminance control is supplied to a spontaneous light emitting element corresponding to one of the plurality of color tones in a pixel, and a correcting current for chromaticity correcting is added to other light emitting element corresponding to at least one of the other color tones in the pixel, wherein,
the main current and the correcting current are controlled by a pulse driving period.

2. The image display apparatus according to claim 1, wherein, each pixel is composed of three color tones of light emitting elements, and
two color tones of light emitting elements other than the light emitting element corresponding to the color tone to be performed chromaticity correcting emit a small amount of light to correct a dispersion of chromaticity of light emitting elements corresponding to each color tone.

3. The image display apparatus according to claim 2, wherein, the three color tones of light emitting elements, of which each pixel is composed, are red, blue and green.

4. The image display apparatus according to claim 1, wherein, the main current and the correcting current are controlled by time-sharing.

5. The image display apparatus according to claim 2, wherein, the main current and the correcting current are controlled by time-sharing.

6. The image display apparatus according to claim 3, wherein, the main current and the correcting current are controlled by time-sharing.

7. The image display apparatus according to claim 1, wherein, amount of light emission by the main current and the correcting current is adjusted by controlling the number of pulse driving or the ratio of frequency of reference clocks (widths of reference clock pulses).

8. The image display apparatus according to claim 2, wherein, amount of light emission by the main current and the correcting current is adjusted by controlling the number of pulse driving or the ratio of frequency of reference clocks (widths of reference clock pulses).

9. The image display apparatus according to claim 3, wherein, amount of light emission by the main current and the correcting current is adjusted by controlling the number of pulse driving or the ratio of frequency of reference clocks (widths of reference clock pulses).

10. The image display apparatus according to claim 4, wherein, amount of light emission by the main current and the correcting current is adjusted by controlling the number of pulse driving or the ratio of frequency of reference clocks (widths of reference clock pulses).

11. An image display apparatus comprising
light emitting elements corresponding to RGB of color tones disposed in each pixel, wherein,
in light emission of each light emitting element Li (i=R, G, B) based on image data Di (i=R, G, B) in respective pixels, amount of light emission Ak+A′k is controlled by the number of pulse driving or the ratio of frequency of reference clocks (widths of reference clock pulses), so as to add amount of light emission A′k (k≠i) of at least one of the other light emitting elements Lk (k≠i) in the respective pixels based on amount of light emission Ai (i=R, G, B) of the light emitting element Li to amount of light emission Ak (k≠i) of the light emitting elements Lk (k≠i) based on image data Dk (k≠i).

12. The image display apparatus according to claim 11, wherein, the amount of light emission A′k (k≠i) of the light emitting elements Lk based on amount of light emission Ai (i=R, G, B) of the light emitting element Li is set so that chromaticity of each pixel based on maximum value of the image data Di (i=R, G, B) is corrected to reference chromaticity.

13. A control method of an image display apparatus with light emitting elements corresponding to a plurality of color tones disposed in each pixel, in which a main current for luminance control is supplied to a spontaneous light emitting element corresponding to one of the plurality of color tones in a pixel and a correcting current for chromaticity correcting is added to other light emitting element corresponding to at least one of the other color tones in the pixel, comprising
a step in that the main current and the correcting current are controlled by pulse driving period.

14. A control method of an image display apparatus with light emitting elements corresponding to RGB of color tones disposed in each pixel comprising
a step in that, in light emission of each light emitting element Li (i=R, G, B) based on image data Di (i=R, G, B) in respective pixels, amount of light emission Ak+A′k is controlled by the number of pulse driving or the ratio of frequency of reference clocks (widths of reference clock pulses), so as to add amount of light emission A′k (k≠i) of at least one of the other light emitting elements Lk (k≠i) in the respective pixels based on amount of light emission Ai (i=R, G, B) of the light emitting element Li to amount of light emission Ak (k≠i) of the light emitting elements Lk based on image data Dk (k≠i).

15. The image display apparatus according to claim 1, wherein, the light emitting elements are light emitting diodes.

16. The control method of an image display apparatus according to claim 8, wherein, the light emitting elements are light emitting diodes.

17. The control method of an image display apparatus according to claim 9, wherein, the light emitting elements are light emitting diodes.

18. The image display apparatus according to claim 4, wherein, a driving period corresponding to one image frame is divided into three divided periods, wherein, a pulse driving current for color tone corresponding to the light emitting element as the main currents is supplied in one of the three divided periods as a main displaying period, and pulse driving currents for color tones corresponding to the other color tones to control the amount of light emission for correcting chromaticity to be added as the correcting currents are supplied in the other two of the three parts as color correcting periods, wherein, amount of light emission by the main current and the correcting currents is adjusted by controlling widths of reference clock pulses.

19. The image display apparatus according to claim 5, wherein, a driving period corresponding to one image frame is divided into three divided periods, wherein, a pulse driving current for color tone corresponding to the light emitting element as the main currents is supplied in one of the three divided periods as a main displaying period, and pulse driving currents for color tones corresponding to the other color tones to control the amount of light emission for correcting chromaticity to be added as the correcting currents are supplied in the other two of the three parts as color correcting periods, wherein, amount of light emission by the main current and the correcting currents is adjusted by controlling widths of reference clock pulses.

20. The image display apparatus according to claim 6, wherein, a driving period corresponding to one image frame is divided into three divided periods, wherein, a pulse driving current for color tone corresponding to the light emitting element as the main currents is supplied in one of the three divided periods as a main displaying period, and pulse driving currents for color tones corresponding to the other color tones to control the amount of light emission for correcting chromaticity to be added as the correcting currents are supplied in the other two of the three parts as color correcting periods, wherein, amount of light emission by the main current and the correcting currents is adjusted by controlling widths of reference clock pulses.
